(19) United States
(12) Patent Application Publication
(10) Pub. No.: US 2021/0371283 A1
(43) Pub. Date: Dec. 2, 2021

(54) Production of carbon by reducing carbon dioxide by means of induced cavitation

(71) Applicant: John H. Bryden, Lynden (CA)

(72) Inventor: John H. Bryden, Lynden (CA)

(21) Appl. No.: 16/873,690

(22) Filed: Jun. 2, 2020

(51) Int. Cl. C01B 32/05; H05H 1/48

(52) U.S. Cl. CPC C01B 32/05; H05H 1/48

(57) ABSTRACT

This invention involves using submerged plasma arcs generated by high voltage capacitors to reduce carbon dioxide in water resulting in the production of free oxygen, carbon, carbon-based molecules including carbohydrates. It promises to be a novel method in manufacturing sugars on a large scale.

### SUMMARY

This invention describes a novel method of obtaining significant quantities (kilograms +) of carbon and carbon containing molecules by the reduction of carbon dioxide. It involves inducing cavitation in water by the acoustic pulses generated by the submerged arc of a high voltage capacitor, also often referred to as a plasma sparker.

The reduction of carbon dioxide by electrolysis is well known—a process which involves an anode and cathode submerged in an aqueous solution containing carbon dioxide. In the presence of suitable catalysts, a variety of carbon-based organic and inorganic molecules can be produced. The electrolysis process is slow however and has not been found to be commercially practical.

A plasma sparker can be thought of as a type of spark plug and in the context of this invention discharging in water rather than air or other gas. Reducing carbon dioxide in water by induced cavitation is quick, efficient and productive.

### DESCRIPTION

It would seem that researchers examining carbon dioxide reduction have not thought to test the effect of a submerged plasma sparker which comprises two electrodes fed by a high voltage capacitor to create a plasma arc when there is sufficient electrical voltage differential between them. It would seem high voltage, unpolarized capacitors have not been the focus of much attention from researchers. There is little literature on their use as agents of chemical reactions.

Some 25 years ago while taking part in research of the effect of acoustic pulses in water as a possible means of controlling zebra mussels and other noxious aquatic organisms in water intake systems, a chance experiment was undertaken to determine the effect of a plasma arc in a closed container containing water and dissolved carbon dioxide. After a few pulses, some of the content of the container was decanted. It was found that the water had turned black. This could only mean the presence of carbon. It was concluded that the carbon dioxide had been reduced to carbon and oxygen, the latter dissipating as bubbles of gas.

The real significance of this result was not appreciated at the time. The researchers speculated that emanating from the arc and reflecting off the walls of the container, the wave fronts of the pulses were caused to converge such that centres of very high pressure were occurring. This phenomenon they recognized as cavitation. At this point, the author of this patent application left the project, and further research on the chemical effects of the plasma arc was centered on the oxidization of complex molecules. The reduction of carbon dioxide was apparently not further explored.

Recently, this writer had cause to consider the hydrodynamics of fluid circulation in the eye. This helped him better understand what had happened chemically in the experiment of years ago. Water is known essentially to neither stretch nor compress. Consequently, force applied to water in a closed system must result in friction, turbulence, or cavitation as a means of absorbing excess kinetic energy. Cavitation is expressed as flashes of very high energy generally understood to be emanating from bubbles in the water under very high pressure. They are observed to be hot enough to cause the pitting of the metal in the propellers of boats and in the bends of pipes. Cavitation is often described in the literature as bubbles of superheated gas. To this writer however, based on the above experiment, the bubbles must be a consequence of cavitation not the cavitation itself.

A more reasonable explanation in the applicant's opinion for the production of points of high energy sufficient to melt steel and radiate light is the breaking apart of the molecules of water due to the stress that occurs when the stream of water is forced to go around a bend, or by an obstacle in a closed or partly closed system.

One can surmise that the added force breaks the chemical bonds and is radiated as heat and light, leaving the freed molecules to recombine in the same or different combination. The resulting arithmetic when carbon dioxide is present with water is this:

Force+Carbon Dioxide+Water=Carbon+Oxygen+Water+Energy

F+CO2+H2O=C+O+H20+Energy

Notice that when read first from the right, the above equation conveniently can describe the oxidization in water of a carbon-based organic molecule such as a carbohydrate. Thus conservation of energy is preserved.

The above-described experiment only dealt with the reduction of carbon dioxide to carbon. It can be expected, however, that with the addition of suitable catalysts in the reaction chamber, other complex molecules of carbon will be the result, as happens with electrolysis.

The points of very high pressure in cavitation will be concentrated along the boundary of the plasma arc. This would appear to be the case with an open flame along the edges of which carbon molecules are sometimes generated and known as soot. Soot is assumed to be unburned carbon fuel but is more likely the result of the reduction of carbon dioxide in water vapor prompted by the force emanating from the flame.

The shape of the reaction chamber can also be expected to contribute to areas of pulse wave front convergence of especially high intensity. A donut-shaped container for instance, would require pulses emanating from the arc to meet head-on and repeatedly.

It should be noted that induced cavitation as a means of producing substantial quantities of carbon and carbon-based molecules is replicated on a large scale in nature, although hitherto not particularly recognized. What is known, however, is that cavitation does occur in plants and can be detected in the vascular systems of trees as an audible cracking. Presumably, cavitation in plants in the presence of the catalyst rubisco is about creating the carbohydrates that have for eons been the molecular building blocks of the prairies and forests of planet earth.

### Elucidation

### Note:

The generally accepted “bubble” explanation for cavitation has a number of difficulties, eloquently illustrated by the many problems associated with trying to apply it to cavitation in plants, a phenomenon definitely known to occur. See, for example, Cavitation and Its Discontents: Opportunities for resolving Current Controversies. Fulton E. Rockwell, James K Wheeler and N Michele Holbrook. Plant Physiology April 2014, 164(4) 1649-1660; DOI: https://dol.org/10.1104/pp.113.233817

On the other hand, if cavitation is considered to be caused by submerged plasma arcs in the vascular cells of plants, what happens as a result provides a more tractable explanation. What is suggested is that some plant cells contain plant-made electrodes which draw alternating current power from high voltage capacitors that the plant made itself. This would be a highly efficient way to power the system with AC solar energy. It is to be further noted that the dielectric separators in manufactured capacitors typically are made of paper. It is proposed that plants themselves make their own sparking devices. The shock waves from the detonation of the arcs would also be reflected off the walls of the vascular cell to create nodes of cavitation that would not do structural damage. They would however reduce the carbon dioxide in the water system in the plant to produce a wide range of plant carbohydrates and free oxygen gas to power the flow of the sap. The action would be on a microscopic or even molecular scale. This might seem farfetched, but it is surely more plausible than the convoluted “bubble” explanation.

In the presence of a suitable catalyst, especially the ubiquitous rubisco, plant sugars could be expected to be produced. This offers an alternate to the presently accepted view of how photosynthesis works in plants.

1) The production of carbon in bulk by reducing carbon dioxide in water by means of cavitation induced by the submerged plasma arcs generated by high voltage capacitors.

2) The use in a reaction chamber, or other water-filled reservoir, of suitable catalysts to create complex carbon-based molecules during the reduction of carbon dioxide by means of cavitation induced by submerged plasma arc discharges.

3) The use of plasma arc discharges to reduce carbon dioxide gas to carbon solids in streams of water vapor.

4) The use of a donut-shaped reaction chamber for the reduction of carbon dioxide by means of a submerged plasma arc discharge.

5) The inducing of cavitation in water by a plasma sparker or other means for the purpose of producing organic or inorganic carbon-based molecules in quantity, including sugars.
